(19) United States
(12) Patent Application Publication
(10) Pub. No.: US 2021/0220916 A1
(43) Pub. Date: Jul. 22, 2021

(54) DIRECTED ENERGY SINTERED INTERFACIAL MODIFIER COATED METALLIC PARTICULATE

(71) Applicant: Tundra Composites, LLC, White Bear Lake, MN (US)

(72) Inventor: Kurt Heikkila, Marine on the St. Croix, MN (US)

(73) Assignee: Tundra Composites, LLC, White Bear Lake, MN (US)

(21) Appl. No.: 17/151,103

(22) Filed: Jan. 15, 2021

Related U.S. Application Data
(60) Provisional application No. 62/961,984, filed on Jan. 16, 2020.

(51) Int. Cl. B22F 10/28; B22F 1/02; B22F 1/00; B33Y 10/00; B33Y 40/10; B33Y 70/10

(52) U.S. Cl. CPC B22F 10/28; B22F 1/02; B22F 1/0011; B33Y 10/00; B22F 2304/10; B33Y 70/10; B22F 2301/052; B22F 2301/35; B33Y 40/10

(57) ABSTRACT

Disclosed are interfacially modified metal particulate materials for use in powder metallurgy direct energy sintered products and processes.

### CROSS REFERENCE TO RELATED APPLICATIONS

This application claims the benefit of U.S. Provisional Patent Application Ser. No. 62/961,984, filed Jan. 16, 2020, herein incorporated by reference in its entirety.

### FIELD

An interfacially modified metal particulate can be sintered into structural article or object.

An interfacially modified particulate can be contacted by a direct energy source in forming a sintered structural object.

### BACKGROUND

Metal particulate/powders can be used in injection molding, in press and sinter and in metal injection molding (MIM) processes. Recent developments include the utility of new materials and manufacturing techniques in selective laser sintering. Precise shapes that perform uses in many commercial and consumer-based products have been made. Applications include automotive applications, aerospace applications, consumer durable goods, computer applications, medical applications and others.

In general, products are made by obtaining raw materials, such as inorganic, ceramic or elemental or alloy metal powders. These powders can be formed and shaped to obtain a shaped inorganic or metal object. After initial processing, finishing steps including machining, heat treatment, steam treatment, composite formation, plating, etc. can be used in forming a final finished product.

Metal particulate or powders can used in the past with some success. Detailed descriptions of such methods may be found in U.S. Pub. No. 2018/0002785, and U.S. Pat. Nos. 4,863,538; 4,944,817; 5,017,753; 5,076,869; 10,124,408 and 10,221,468.

Many of these techniques are inadequate for manufacturing high quality metal parts without further conventional metal processing. Particularly obtaining maximized density and the associated tensile properties are difficult to attain. Often these processes use uncoated particles which reduce packing density and introduce defects, including impurities, voids or areas of varying density in the final product. Such defects can affect the performance of the product when used. A substantial need exists to overcome these difficulties associated with the prior directed energy methods.

A substantial need exists for the improvement of sintering processing of a sintered product. A substantial need exists to improve metal powder molding techniques such that the processes are improved, the energy to form the part is reduced and the part formed in the process is completed without the processing problems.

### BRIEF DESCRIPTION

We have found that a metal particulate with a coating of an interfacial modifier (IM) can be formed and sintered into an article with a directed energy selective sintering method. A metal particulate having a uniform coating of an interfacial modifier comprising an organometallic compound can be used in forming a sintered structural article or object. The object or article can be formed from the metal particulate using a directed energy beam of a defined size and energy to sinter selectively a portion of a layer of particulate into the desired object. In the process, the digital image of the object to be formed is stored in the computer and the object is analyzed to obtain a series of digital images of layers that together form the object. When the process is run the layers are sintered serially (in order) until the object is formed from the combined layers. Once completed unsintered coated particles can be removed leaving the object for post sinter processing if needed. Directed energy methods direct a small area of energy to an IM coated particulate to cause sintering. Workable methods include E-beam and Laser heating.

An object can be made by serially sintering thin layers of IM coated metal particles until the serial/repeated sinter process resolves the powder into a final metal product. Unsintered particulate can be easily removed and the product can be finished with post sintering techniques.

The term “final sintered article” as used in this disclosure refers to the final product of the sinter process. The term “final shaped article” refers to the article after sintering and after post sintering methods. A final product containing metal particles and the unique bonding scheme is made by first forming a layer and exposing the layer to energy until it forms the unique particle-to-particle bonding resulting in the final product shape. In the final shaped article, after sintering, each interfacially modified particle surface is bonded to at least one other interfacially modified particle surface at a particle to particle bond comprising a combination of the metal of each particle and the metal of the organo metallic interfacial modifier. Articles can have a complex form or can have a major dimension greater than 15 cm or greater than 20 cm.

The term “particle” refers to a single unit of a particulate.

The term “particulate” refers to a collection of finely divided particles. The particulate has a range of types, sizes and morphologies. The particulate may be chemically the same or chemically different. The maximum particle size is less than 500 microns. In referring to particle sizes, the term “D₅₀ less than 500 micron” means that 50 wt. % of the particulate is less than 500 microns. Similarly, the term “D₉₀ of 50 to 100 nm” means that 90 wt. % of the particulate is between 50 and 100 nm. A formed body containing the interfacially modified particulate is sintered at elevated temperature to form a desired object. The term includes materials called “nano-powders” with a D₉₀ of 10 to 50 nm.

The term “element” refers to an element of the periodic table of elements.

The “packing density” is a measure of the density of the packed particulate compared to the density of the material. The term “ordered”, or “ordering” refers to the nature of the coated particles forming a maximum density particle array. Uncoated particles will randomly pack and result in a less than maximum density of the packed particles. IM coated particles have the inter-particle forces minimized such that the particles can obtain close packing. In mono-disperse particles, an ordered array is formed. In bimodal dispersion, the larger and smaller particles can form an array having smaller particles occupy the spaces between the larger ones and increase packing density. Similarly, in dispersions of more than two particulates, the smaller particles can further occupy the spaces formed in the overall ordered array. The smallest particles can fill the smallest voids, while larger particles fill other larger voids.

The term “modified particle surface” refers to the presence of the IM on the particle surface or the presence of non-volatile components of the IM in the bonding area on the adjacent particle surfaces after sintering.

The term “coating” refers to any material added to the surface of a particle, which can be but is not necessarily continuous. The interfacial modifier coating can be substantial or continuous. After sintering, the remaining non-volatile metal from the interfacial modifier can be non-continuous.

The term “sinter” refers to a process in which a particulate is heated by controlled direct energy to a temperature that causes particle to particle binding to form a solid. In a sinter process the particle itself does not melt but the energy of surface atoms on the particle causes atomic migration or diffusion among or between adjacent particles to form bonds that cause a solidification at the surface. In the claimed sintering, the temperature is enough to bond particles, to drive off all volatile or organic materials such as organic components of the interfacial modifiers but not so high as to melt or liquify the bulk of the particulate. During the claimed sintering, the non-volatile or metal component of the interfacial modifier remains as a surface distribution, component or coating on a particle derived from the interfacial modifier after heating and aids in particle bonding.

The term “directed energy” refers to enough controlled energy to selectively sinter the IM coated metal into layers forming a useful product.

The term “elevated temperature” refers to a temperature for the thermal process to cause temperature driven particle surface bonding or removal of organic materials such as interfacial modifier moieties. Sintering is done at a temperature or temperature profile and time enough to cause the particulate to form a solid object. Such object formation can occur by any temperature driven particulate bonding including atomic diffusion, some softening, minimal melting, etc. Intact particle to particle edge fusion occurs without substantial liquefaction of the metal particles. Significant softening or melting of the particle is to be avoided. In the substantial absence of polymer, no “debinding” step is needed in this technology.

The term “x-y plane” or “x-y dimension” generally refers to a horizontally positioned plane orthogonal to the force of gravity. The z-direction generally refers to the direction normal to or parallel to the force of gravity and substantially orthogonal to the x-y plane.

The term “close association” generally refers to the packing of particles or particulate distribution. The interfacial modifier coating provides a homogeneous surface on the particle or particles even if the particles are dissimilar in composition or size. Said surface of a particle, because of its inert character, permits very high volume or weight fraction packing.

The term “nonoxidizing atmosphere” generally refers to an atmosphere devoid of oxygen and can comprise a substantial vacuum, nitrogen, hydrogen, a noble gas or mixtures thereof.

The term “reducing atmosphere” also includes nonoxidizing characteristics but also includes the chemical nature that only the actions involving electron losses can occur. A “reducing atmosphere” comprises gases such as hydrogen, carbon monoxide, and other gaseous reactants. One aspect of a reducing atmosphere is that it can cause the removal of oxygen from a metal or metal oxide.

The term “or” is generally employed in its inclusive sense including “and/or” unless the content clearly dictates otherwise.

The terms “comprise or comprises” and variations thereof do not have a limiting meaning where these terms appear in the description and claims.

“Include,” “including,” or like terms means encompassing but not limited to, that is, including and not exclusive.

### BRIEF DESCRIPTION OF THE DRAWINGS

FIG. 1 is a chart of the components of an apparatus that can achieve object manufacture using directed energy to sinter IM coated particulate.

FIG. 2 is a top view of the apparatus of FIG. 1

FIG. 3 is a focused chart of the CAD computer control of the sintering processes.

FIG. 4A, FIG. 4B and FIG. 4C are an artist rendering of the particulate before and after sintering.

### DETAILED DISCUSSION

We have found that a metal particulate with a coating of an interfacial modifier (IM) can be formed and sintered with a direct selective energy into a final shaped article.

### Methods

The steps in forming a solid body article by directed energy sintering

### DETAILED DISCUSSION

We have found that a metal particulate with a coating of an interfacial modifier (IM) can be formed and sintered with a direct selective energy into a final shaped article.

### Methods

The steps in forming a solid body article by directed energy sintering may be summarized as follows:
1) Forming particles with IM coating;
2) Forming a layer of particulate;
3) Selective sintering portions of the particulate with a digitally controlled energy beam using a digital model that contains both the object form and layered image of the object;
4) Repeating with additional layers to form the object; and
5) Optional post sintering finishing.

In the article forming aspect of the disclosed materials, the article is initially formed by coating particulate with an interfacial modifier. The interfacial modifier modifies surface energy, reduces particle to particle forces, reduces particle to particle interaction resulting in increased packing density. The particulate interfacial modifier coatings on adjacent particles coalesce at each particle to particle interface. When heated to a sintering temperature (less than the melting point of any metal), substantially all volatile and organics are volatilized and removed. With minimal or no organic materials in the sintered material, a debinding step is often not needed. At the particle/particle interfaces, metal from each adjacent particle and metal from the interfacial modifier diffuse into adjacent particles and can combine with non-volatile metal of the IM to form a sintered bond between particles in a fused mass of sintered particulate.

“Sintering is the process whereby particles bond together typically below the melting point by atomic transport events. A characteristic feature of sintering is that the rate is very sensitive to temperature. The driving force for sintering is a reduction in the system free energy, manifested by decreased surface curvatures, and an elimination of surface area” (Powder Metallurgy Science, 1989, pg. 148). The interfacial modifier on a particle surface may cooperate in the sintering process to the level of fusing with other interfacial modifier coatings on other particles to form the sintered product. The interfacial modified surfaces that fuse or sinter may be the same or different relative to the organo-metallic interfacial modifier. Further, the grain boundary, the interface between particles, may fuse or sinter as well. Sintering temperatures are selected depending on metal to be used and are often about 1100-1500° C.

A container for the serially formed layers can include a movable stage. Such a stage can be helpful in a process such that the first layer of IM coated particulate is formed on the stage and effectively sintered by the directed energy beam. The stage can then be lowered an amount equal to the layer thickness, a subsequent layer can be formed on the sintered layer, which is then sintered, the stage can then be again lowered the appropriate amount and the process repeated until the object is fully formed. In the claimed method the object is formed by sintering successive layers of IM coated metal particulate. The thickness of each layer can be obtained independently of other layers and each layer can be independently from about 1 to about 5000 microns, 5 to about 2000 microns, about 10 to 1000 microns or 20 to 200 microns depending on the nature of the final object needs.

Direct Energy

The claimed method is a low-cost and highly productive method that can form an article, object, or other metal part wherein many thin layers as defined by the computerized or CAD layering routines or programs are sequentially sintered into the final object structure. Layers of the interfacial modified powdered material are serially/sequentially formed and directly exposed to the directed energy beam at enough power and residence time such that the particulates are effectively sintered or fused without melting to solidify each layer into the final object. The sintering is directed to selective portions of the object that can be built up into a final structure. When needed, the serial/sequential sintering process of the claimed method can be used in a reducing or inert atmosphere. An inert atmosphere generally comprises non-reactive gasses such as helium or nitrogen. Reducing atmospheres typically include gases such as hydrogen that can be combined with other more inert atmospheres.

The claimed method involves additive manufacturing process employing a directed energy beam to sinter a coated powder material to produce an object. The claimed method uses a pulsed or continuous wave directed energy beam to achieve a sintered solid object having maximized density and structural properties. In general, the claimed method involves using a computer aided design (CAD) model which uses either a pulse or continuous wave laser or a directed electron beam or other electromagnetic radiation to sinter the powdered material into a solid, useful three-dimensional object. Directed energy sintering including laser sintering or electron beam sintering refers to producing a three-dimensional (3D) object from series of a two-dimensional (2D) finely powdered interfacial modified coated metal particulate layer. These directed beam sintering methods entail using a CAD program to form a digital image of an object resolved into discrete layers that can be serially formed.

In the method as claimed, each digitized or CAD layer of the object is used to form an actual sintered metal layer form the interfacial modified coated particulate which is then exposed to the effects of the directed energy beam which centers selectively onto only that portion of the particles that will become the first layer of the object as it is defined by the CAD code. By adjusting the position and residence time of the laser beam in a controlled manner in the x-y plane, a selective layer of the object can be formed by sintering where the controlled diameter of the directed energy contacts the powdered material. The laser can be used to scan the surface of the layer in any ordered or random pattern except that the directed energy is only energized when needed to contact the particle layer in only selective and useful areas. The method further comprises forming additional thin layers of powdered material, repeating the directed energy scan to form the next and subsequent layers of the formed object until the object is fully complete. Once the object is complete, the unsintered particulate can be removed and the object can then be directed to post-process completion.

The claimed method of fabricating objects uses a directed energy beam in a controlled method to sinter a portion of a thin layer of an IM coated metal particle in order to sinter the particles into a first portion of a desired object. After the first layer is formed, at least one additional layer is formed on the first layer and the directed energy beam is then applied to that second layer to further form an additional portion of the desired object. This process is repeated until the CAD image of the object is completed by forming all the defined digital layers in the object.

The claimed method involves the use of a directed energy source such as a continuous wave or pulsed laser beam or electron beam that is directed to the interfacial modified coated particle material at enough energy levels to cause sintering. Effective control of the directed energy can control the amount of heat applied by the beam to achieve enough energy to sinter the particles but avoid any substantial melting. The use of the IM coated particulate results in a layered collection of particles that, due to the presence of the coating, can achieve a self-ordering by particulate size array, which as a result reduces or avoids any product defects such as voids, impurities, or micro-cracks or variations in density that can cause problems in the product. The claimed method uses a container in which the layered powder can be placed for directed energy sintering.

One aspect of the claimed method involves the use of a laser system. The laser system typically forms a beam with a relatively narrow effective diameter as the diameter is reduced the ability to form small details in the workpiece is increased, but productivity is reduced. The effective diameter also called the D₈₆ can range from as little as about 10 micron to 500 micron. The beam also must have a wavelength and power enough to cause sintering in the powdered layer within the resonance time of the beam. Both continuous wave and pulse laser beams can be used, including such lasers as YAG lasers, CO₂ lasers and others of enough power.

Laser

The laser emits coherent electromagnetic radiation emitting devices using light amplification by stimulated emission of radiation at wavelengths from 180 nanometers to 1 millimeter. The electromagnetic spectrum includes energy ranging from gamma rays to visible wavelengths. The direct energy laser beam power can be from about 10 to about 2000 watts or from about 15 to about 1500 watts or about 20 to about 500 watts as necessary for sintering the selected metallic coated particulate. The directed energy beam can be applied to the powdered layer and moved from place to place depending on the CAD program at a velocity in the X-Y plane that can range from one to about 2000 millimeters per second or about 100 to about 2000 millimeters per second or about 200 to 500 millimeters per second as needed to sinter the selected coated metal particulate. The directed energy beam effective diameter can range from as little as about 10 micron or about 20 to 100 micron. If desired, the CAD program can ensure that the subsequent laser beams overlap previous laser beam patterns by one to about 50% of the incident beam diameter. These sintering methods require the use of high-powered lasers with energy of about 100 to 5000 watts or 100 to 2000 watts.

E-beam

E-beam energy can be used in the sintering methods. Electrons are elementary particles possessing a mass and a negative electrical charges that can be used as an energy source free electrons in vacuum. Free electrons in vacuum can be accelerated, with their paths controlled by electric and magnetic fields. In this way narrow beams of electrons carrying high kinetic energy can be formed, which upon collision with atoms in solids transform their kinetic energy into heat. Electron-beam sintering conditions involve strong electric fields, which can accelerate electrons to a very high speed. Thus, the electron beam can carry high power, equal to the product of beam current and accelerating voltage.

Sintering Methods

The laser or e-beam power can be increased to practical sintering or heating values.

Values of power density in the crossover (focus) of the beam can be as high as 10⁹ W-mm⁻² or 10⁴-10⁷ W-mm⁻². The effectiveness of the beam depends on many factors. The most important are the physical properties of the materials to be heated. For practical applications the power of the beam must, of course, be controllable. As mentioned above, the position and size of the beam spot should be very precisely positioned with respect to the metal to be sintered. This is commonly accomplished mechanically by moving the workpiece with respect to the electron gun, but sometimes it is preferable to move the beam instead. Directing the beam onto a small diameter spot on the surface of the particulate, obtains values of planar power density as high as 10³ W-mm⁻² or as high as 10⁴ up to 10⁹ W-mm⁻². The power density in this volume can be extremely high. The volume density of power in the small volume in which the kinetic energy of the electrons is transformed into heat can reach values of the order 10⁵-10⁹ W-mm⁻². Consequently, the temperature in this volume increases extremely rapidly, by 10⁸-10⁹ K-s⁻¹ to sinter with no substantial melting. Various forms of sintered zone can depend on several factors that the effect of the beam, i.e. the size and shape of the zone influenced by the beam depends on beam power. The equipment should enable adjustment of the relative speed of motion of the beam vis a vis work in wide enough limits, e.g., between about 0.1 and 50 mm-s⁻¹ or 0.5 to 2 mm-sec⁻¹.

IM

The IM has a dual function. The IM helps order the particles by size before sintering. The ordered particles can be sintered into a final product in which the IM cooperates to form a unique bonding between particles. These techniques form a product that can be useful, stiff, strong, bonded product or structural article via sintering to form a unique particle/particle bonding structure and enhanced properties.

The sintered particle/particle bond includes combinations of atoms of at least one element from each particle surface in a bond structure combined with non-volatile and bonding atoms from the interfacial modifier (IM). In this context, “non-volatile” is determined at or near the maximum sintering temperature of the material. At sintering temperatures, substantially all organics, including organic components of the interfacial modifier (IM) are volatilized and are removed from the product. In sintering, atoms from the particle surfaces migrate or diffuse from adjacent particle to particle and combine with non-volatile atoms remaining from the organo metallic interfacial modifier (IM) to form a unique bonding at surface contact points. The nonvolatile potion of the IM becomes a part of the bonding between surfaces, and simply modifies the surface where it is cooperating in a bonding between particles. The particles after sintering have the nonvolatile portions on the particle surface but the interior of the particle is substantially free of the IM and its components. As IM organics are thermally removed, atoms from the particle surfaces migrate or diffuse from particle to particle and combine with atoms remaining from the interfacial modifier that in turn diffuse to form a unique bonding structure at particle surface contact points. The articles can be made into complex shapes, articles with a major dimension greater than 15 cm.

During sintering, the presence of the nonvolatile portions of the IM can obtain improved properties include hardness, toughness, luster, corrosion resistance, malleability, ductility, density, tensile properties and modulus.

Metal Particulate

The metal powder particles or particulate can consist of a single metal, an alloy of two or more metals or a dispersion of two or more metals. The metal particulate may have electromagnetic properties depending on the article's or object's composition and application. The metal can be a single crystal or many crystal grains of various sizes. The microstructure including a crystal grain size shape and orientation can also vary from metal to metal. The particle metallurgy depends on method of the particle fabrication. Metals that can be used in powder metal technology include copper metal, iron metal, nickel metal, tungsten metal, molybdenum, and metal alloys thereof and bi-metallic particles thereof. Often, such particles have an oxide layer that can interfere with shape formation. The metal particle composition used in particle metallurgy typically includes many particulate size materials. The particles that are acceptable molding grade particulate include particle size, particle size distribution, particle morphology and aspect ratio.

Metal particulate that can be used in the solid body molded materials include ferrous alloys, stainless steel, nickel alloys, chromium alloys, titanium alloys, cobalt alloys, aluminum, iron, copper, nickel, cobalt, tin, bismuth, zinc, tungsten, uranium, osmium, iridium, platinum, rhenium, gold, silver, neptunium, plutonium and tantalum. These metals may be used alone or as an alloy or in conjunction with other metals, inorganic minerals, ceramics, or glass bubbles and spheres.

The end use of the material to make the shaped article would be the determining factor. Another advantage is the ability to create bimetallic or higher materials that use two or more metal materials that cannot naturally form an alloy. These materials are not used as large metal particles, but are typically used as small metal particles, commonly called metal particulates. Such particulates have a relatively low aspect ratio and are typically less than about 1:3 aspect ratio. An aspect ratio is typically defined as the ratio of the greatest dimension of the particulate divided by the smallest dimension of the particulate. Using the interfacial modifier coating enables the part or shaped article to be made from particles of varied and amorphous morphology.

In a final shaped article, the coating of interfacial modifier on the particulate results in substantially reduced shrinkage (shrinkage of about 1 to 13% or 1 to 10% or 1 to 5% based on the mass of coated particles) of the mass of particulate when compared to particulate not coated with interfacial modifier. Reduced shrinkage results from the increased packing density of the particulate before sintering and provides reproducibility of the part or shaped article. Further, the interfacial modifier coating permits very high packing fractions of the particles as the particles tend to self-order themselves to achieve the highest packing density in a volume of the particles. The resulting final shaped article products can exceed contemporary products at least in tensile strength, impact strength and density.

The metal particles generally useful in the claimed materials typically have a particle size of a minimum of 2, 5, 10, 20 microns or a maximum of 180, 250, 300, 500 etc. microns that range from about 2 to 500, 2 to 400, 2 to 300, to 200, or 2 to 100 microns, 4 to 300, 4 to 200, or 4 to 100 microns, and often 5 to 250, 5 to 150, 5 to 130, 5 to 125, or 5 to 100 microns. A single particle size, two blended particles or three or more particles in a blend can be used. The packing can be about 70 to 85 or about 74 to 82%. Blended particles can attain higher packing levels. A combination of a larger and a smaller particle can obtain higher packing of 82 to 90% wherein there is about 0.1 to 40 or 5 to 35 wt. % of the smaller particle and about 99.9 to about 60 or 95 to 65 wt. % of larger particles, and where the ratio of the diameter of the larger particles to the ratio of the smaller particles is about 2:1, 3:1, 4:1, 5:1, 6:1 or 7:1. In some embodiments there may be three or more components of particle sizes with size ratios such as about 50:7:1 or 350:50:7:1. In other embodiments there may be a continuous gradient of wide particle size distributions to provide higher packing densities or packing fractions that can be about 82 to 90%. These percentages are based on the particulate. In some embodiments, there may be two or three or more components of particle sizes with specific size ratios. In two particulate blends, a first particulate that is greater than 100 microns is combined with a particulate that is less than 20 or less than 10 microns at a ratio of larger to smaller particulate of about 3-1 parts by weight of the larger to 1 part of the smaller. In three particulate blends, a first particulate that is greater than 100 microns is combined with a second particulate that is about 50 to 10 microns and a third particulate that is less than 10 microns at a ratio of first to second to third particulate of greater than about 10 parts by weight of the first to about 1 part of the second to less than about 5 of the third. These ratios will provide optimum self-ordering of particles leading to tunable particle fractions within the sintered material. The self-ordering of the particles is improved with the addition of interfacial modifier as a coating on the surface of the particle.

The sole or major amount of particulate in the product is a metal particulate. Optional minor amounts of component materials can be used as a particulate in combination with metal includes inorganic and ceramic materials.

Glass spheres (including both hollow and solid) are another illustrative non-metal or inorganic particulate useful in the claimed materials. These spheres are strong enough to avoid being crushed or broken during further processing, such as by high pressure spraying, kneading, extrusion or injection molding. In many cases these spheres have particle sizes close to the sizes of other particulate if mixed as one material. Thus, they distribute evenly, homogeneously, within the sintered material upon introduction and mixing. The method of expanding solid glass particles into hollow glass spheres by heating is well known. See, e.g., U.S. Pat. No. 3,365,315 herein incorporated by reference in its entirety.

Useful hollow glass spheres having average densities of about 0.1 grams-cm⁻³ to approximately 0.7 grams-cm⁻³ or about 0.125 grams-cm⁻³ to approximately 0.6 grams-cm⁻³ are prepared by heating solid glass particles.

For a product of hollow glass spheres having a desired average density, there is an optimum sphere range of sizes of particles making up that product which produces the maximum average strength. A combination of a larger and a smaller glass sphere wherein there is about 0.1 to 25 wt. % of the smaller sphere and about 99.9 to about 75 wt. % of larger particles can be used were the ratio of the diameter of the larger particles to the ratio of the smaller is about 2:1, 3:1, 4:1, 5:1, 6:1 or 7:1. Percentages based on the particulate. Glass spheres used within the embodiments can include both solid and hollow glass spheres. All the particles heated in the furnace do not expand, and most hollow glass-sphere products are sold without separating the hollow from the solid spheres.

Useful glass spheres are hollow spheres with relatively thin walls. Such spheres typically comprise a silica-lime or a silicate glass and in bulk form a white powdery particulate. The density of the hollow spherical materials tends to range from about 0.1 to 0.8 g-cm⁻³ that is substantially water insoluble and has an average particle diameter that ranges from about 10 to 250 microns.

Magnetic particle material can be formed and can be magnetized to obtain a permanent magnetic field. These particles are typically inorganic and can be ceramic. If raised to above a Curie temperature (Tc) with a loss of magnetic moment alignment, magnetism can be restored by conventional means. Magnetite is a mineral, one of the two common naturally occurring oxides of Iron (chemical formula Fe₃O₄) and a member of the spinel group. Magnetite is the most magnetic of all the naturally occurring minerals. Alnico magnet alloy is largely comprised of aluminum, iron, cobalt and nickel. Alnico is a moderately expensive magnet material because of the cobalt and nickel content. Alnico magnet alloy has a high maximum operating temperature and a very good corrosion resistance. Some grades of Alnico alloy can operate at high temperatures. Samarium cobalt (SmCo) and Neodymium Iron Boron (NdFeB) are called rare earth because neodymium and samarium are found in the rare earth elements on the periodic table. Both samarium, cobalt, and neodymium magnet alloys are powdered metals which are compacted in the presence of a strong magnetic field and are then sintered. Ceramic magnet material (Ferrite) is strontium ferrite. Ceramic magnet material (Ferrite) is one of the most cost-effective magnetic materials manufactured in industry. The low cost is due to the cheap, abundant, and non-strategic raw materials used in manufacturing this alloy. The permanent ceramic magnets made with this material lend themselves to large production runs. Ceramic magnet material (Ferrite) has a fair to good resistance to corrosion and it can operate in moderate heat.

Iron oxide compounds are materials containing iron and oxygen atoms. Most iron oxides do not exactly conform to a specific molecular formula and can be represented as Fe₂O₃ or Fe₃O₄ as well as compounds as FeₓO_{y} wherein x is about 1 to 3 and y is about 1 to 4 including non-unitary substituents. The variation in these numbers result from the fundamental nature of the ferric oxide material which invoke often does not have precisely defined ratios of iron to oxygen atoms. These materials are spinel ferrites and are often in the form of a cubic crystalline structure. The crystalline usually synthetic ceramic material typically is manufactured by manufacturing a ferric oxide material and at least one other metallic oxide material generally made from a metal oxide wherein the metal is a divalent metal. Such metals include for example magnesium, calcium, barium, chrome manganese, nickel, copper, zinc, molybdenum and others. The useful metals are magnesium, calcium and barium.

Useful ferrites are typically prepared using ceramic techniques. Often the oxides are carbonates of iron or divalent oxides are milled until a fine particulate is obtained. The fine particulate is dried and pre-fired to obtain the homogenous product. The ferrite is then often heated to form the final spinel crystalline structure. The preparation of ferrites is detailed in U.S. Pat. Nos. 2,723,238 and 2,723,239. Ferrites are often used as magnetic cores in conductors and transformers. Microwave devices such as glycerin tubes can use magnetic materials. Ferrites can be used as information storage in the form of tape and disc and can be used in electromagnetic transistors and in simple magnet objects. One useful magnetic material is known as zinc ferrite and has the formula ZnₓFe₃₋ₓO₄. Another useful ferrite is the barium ferrite that can be represented as BaO:6Fe₂ or BaFe₁₂O₁₉. Other ferrites include soft ferrites such as manganese-zinc ferrite (MnₐZn₍₁₋ₐ₎Fe₂O₄) and nickel zinc ferrite NiₐZn₍₁₋ₐ₎Fe₂O₄. Other useful ferrites are hard ferrites including strontium ferrite SrFe₂O₄, cobalt ferrite CoFe₂O₄.

Interfacial Modifier (IM)

We have found that by using an interfacially modified coated particulate or particulate blend that the molding processes can be improved. The packing density, or packing fraction, is a useful predictor of the properties of the resulting products. The improved packing density typically has improved the strength, shielding properties, shape, definition, etc. of the final sintered product or shaped solid body article. Once formed layers of the coated particulate can be sintered to form a particle mass bonded with a unique bond structure in which the IM residue and the metal forms a bond structure.

The articles having the desired physical properties can be manufactured as follows. In a useful mode, the surface coating of the particulate with the interfacial modifier is initially prepared. The interfacial modifier is coated on the prepared particle material. The coating of the interfacial modifier on the particle is less than 1 micron thick, in some cases atomic (0.5-10 Angstroms) or molecular dimensions (1-500 Angstroms) thick.

We believe an interfacial modifier is a surface chemical treatment. In one embodiment, the interfacial modifier is an organo metallic material that provides an exterior coating on the particulate promoting the close association of particulate to other particulate without intra-particulate bonding or attachment. Depending on the requirements and specifications for making an article the particulate can be coated with 0.005% to 1, 2, 3, 4, 5, 6, 7, 8, 9 or 10 wt. % interfacial modifier relative to 35% to 40, 55, 60, 65, 70, 75, 80, 85, 90, or 95 vol. % of particulate, The volume percentage based on the particulate, all depending on particulate and blending ratios.

The weight percent of interfacial modifier is based on the metal weight. The interfacial modifier coats but does not form any substantial covalent bonding among or to other particulate until sintering is achieved.

Organometallic interfacial modifiers provide the close association of the particulate within a particle distribution of one or many sizes. Interfacial modifiers used in the application fall into broad categories including, for example, titanate compounds, zirconate compounds, hafnium compounds, samarium compounds, strontium compounds, neodymium compounds, yttrium compounds, metal phosphonate compounds, aluminate and metal aluminate compounds. Useful, aluminate, phosphonate, titanate and zirconate compounds contain from about 1 to about 3 ligands comprising hydrocarbyl phosphate esters and/or hydrocarbyl sulfonate esters and about 1 to 3 hydrocarbyl ligands which may further contain unsaturation and heteroatoms such as oxygen, nitrogen and sulfur. Commonly the titanate and zirconate compounds contain from about 2 to about 3 ligands comprising hydrocarbyl phosphate esters and/or hydrocarbyl sulfonate esters, commonly 3 of such ligands and about 1 to 2 hydrocarbyl ligands, commonly 1 hydrocarbyl ligand.

In one embodiment, the interfacial modifier used is a type of organo-metallic material such as organo-titanate, organo-boron, organo-aluminate, organo-strontium, organo-neodymium, organo-yttrium, or organo-zirconate compounds. The specific type of organo-titanate, organo-aluminate, organo-hafnium, organo-strontium, organo-neodymium, organo-yttrium, or organo-zirconate compounds may be referred to as organo-metallic compounds and are distinguished by the presence of at least one hydrolysable group and at least one organic moiety. Mixtures of the organo-metallic materials may be used. The mixture of the interfacial modifiers may be applied inter- or intra-particle, which means at least one particle may have more than one interfacial modifier coating the surface (intra), or more than one interfacial modifier coating may be applied to different particles or particle size distributions (inter). These types of compounds may be defined by the following general formula:

M(R₁)ₙ(R₂)ₘ

wherein M is a central atom selected from, for example, Ti, Al, Hf, Sa, Sr, Nd, Yt, and Zr; R₁ is a hydrolysable group; R₂ is a group consisting of an organic moiety; wherein the sum of m+n must equal the coordination number of the central atom and where n is an integer ≥1 and m is an integer ≥1.

Particularly R₁ is an alkoxy group having less than 12 carbon atoms. Useful are those alkoxy groups, which have less than 6, and most Useful are alkoxy groups having 1-3 C atoms. R₂ is an organic group including between 6-30, commonly 10-24 carbon atoms optionally including one or more hetero atoms selected from the group consisting of N, O, S and P. R₂ is a group consisting of an organic moiety, which is not easily hydrolyzed, often is lipophilic and can be a chain of an alkyl, ether, ester, phospho-alkyl, phospho-alkyl, phospho-lipid, or phospho-amine. The phosphorus may be present as phosphate, pyrophosphato, or phosphito groups. Furthermore, R₂ may be linear, branched, cyclic, or aromatic. R2 is not reactive to other IM coatings with similar chemical constructions.

Useful titanate and zirconate compounds include isopropyl tri(dioctyl)pyrophosphato titanate (available from Kenrich Chemicals under the designation KR38S), neopentyl(diallyl)oxy, tri(dodecyl)benzene-sulfonyl titanate (available from Kenrich Chemicals under the trademark and designation LICA 09), neopentyl(diallyl)oxy, trioctylphosphato titanate (available from Kenrich Chemicals under the trademark and designation LICA 12), neopentyl(diallyl)oxy, tri(dodecyl)benzene-sulfonyl zirconate (available from Kenrich Chemicals under the designation NZ 09), neopentyl(diallyl)oxy, tri(dioctyl)phosphato zirconate (available from Kenrich Chemicals under the designation NZ 12), and neopentyl(diallyl)oxy, tri(dioctyl)pyro-phosphato zirconate (available from Kenrich Chemicals under the designation NZ 38). One embodiment is titanate is tri(dodecyl)benzene-sulfonyl titanate (available from Kenrich Chemicals under the designation LICA 09).

The interfacial modifiers modify the particulate with the formation of a layer on the surface of the particle reducing the intermolecular forces, improving the tendency of particle to mix with other particles, and resulting in increased material density Further, the interfacial modifier coatings on particulate provide an inert surface on the particulate substrate due to the non-reactivity of the R₂ group. Density is maximized as the number of close associations between the particulate surfaces. After sintering the IM leaves non-volatile reside on the surface that typically is the metallic portion of the IM. This residue can cooperate to form a bond with the particle surface.

The choice of interfacial modifiers is dictated by particulate, and application. The particle is completely coated with the interfacial modifier even if the particulate has substantial surface morphology. By substantial surface morphology, visual inspection would show a rough surface to a particle substrate where the surface area of the rough substrate, considering the topography of the surface, is substantially greater than the surface area of a smooth substrate. After treatment with the interfacial modifier, the surface of the particle behaves as a particle of the non-reacted end of the interfacial modifier. The interfacial modifier coating of the surface of the particle modifies the surface energy of the bulk particulate relative to the surface characteristics of the interfacial modifier.

Interfacial modifying coatings or surface treatments may be applied to any particle type such as ceramic, inorganic, metal particulate or their mixtures. The maximum density is a function of the densities of the materials and the volume fractions of each. The self-ordering effect of the IM coatings allows the particulate to pack to a very high-volume percent prior to sintering. Higher density materials are achieved by maximizing per unit volume of the materials with the highest densities and can be measured by application of Equation 1.

In accordance with disclosed concepts, the packing density or particle fraction of particles in the layer material (molded or additive processed) is improved. The density varies to specifications required for the utility of the final shaped product as molded and sintered. Values for packing density, the volume percent, may be greater than 60, 65, 70, 75, 80, 85, 90, 97%. Packing can also be seen in the amount of excluded volume. Excluded volume (outside particulate) can range from 10 to 80 vol. %, 10 to 70 vol. %, 13 to 61 vol. % 3 to 22 vol. % or 5 to 18 vol. %. Packing percentage can also be seen in the amount of excluded volume. These coated particles are not only non-reactive to each other but also provide self-ordering among particles and reduce the friction between particles thereby preventing gouging and allowing for greater freedom of movement among and between particles in comparison to particles that do not have a coating of interfacial modifier or have a coupling agent on their surface until sintering is achieved.

The Packing Density

The packing density, or particle fraction of particles, in the material varies to specifications required for the utility of the final shaped product as molded and sintered. Values for packing density, volume percent, may be greater than 50, 55, 65, 70 75, 80, 85, 90, 95, or 99 vol. %. Volume percentages are based on the totality of the particulate fractions.

Excluded volume is the volume not occupied by the IM coated particulate. In large part, this excluded volume is substantially or fully filled with smaller particles. Such a combination provides minimal shrinkage less than 10, 9, 8, 7, 6, 5, 4, 3, 2 or 1 vol. %, and absence of polymer permits part manufacture to avoid a debinding step.

Packing (Loading)(%)=packed powder density/condensed material density (Eq. 1)

In the case of metals, the materials may be refractory metals such as niobium, molybdenum, tantalum, tungsten and rhenium and in some instances titanium, vanadium, chromium, zirconium, hafnium, ruthenium, osmium and iridium. Useful metals are ferrous metals and alloys thereof, such as stainless steel. These materials are extremely hard, have a high melting point, usually above 1500° C., and are difficult to deform. These materials may be formed into usable shapes using traditional powder metallurgy equipment. However, the maximum densities achievable with conventional materials will be less then optimum and there may be excessive shrinkage of the particulate mass upon sintering. When forming shaped articles, or linear extrudate, the inter-particle interaction dominates the behavior of the total material. Particles contact one another and the combination of irregular shape, interacting sharp edges, soft surfaces (resulting in gouging, points are usually work hardened) and the friction between the surfaces prevent further or optimal packing. Further because of this inter-particle friction, the forming pressure will decrease exponentially with distance from the applied force. The circularity of the particle is calculated by the following Equation 2:

Circularity=(perimeter)²/area. (Eq. 2)

An ideal spherical particle has a roundness characteristic of about 12.6. This characteristic is a unitless parameter of less than about 100, often about greater than 15 and can be between 20 to 50. Non-spherical particles can have improved physical properties arising from the interactions between the more irregular shapes, the aspect ratio of the particulate, L/D, is less than 3:1

During powder metallurgical operations, such as sintering, each modified particle surface is bonded to at least one other modified particle surface at a particle to particle bond comprising a particle edge fusion interaction comprising a combination of the metal atoms from each particle and the metal of the organo metallic interfacial modifier. In ferrous metal bonding, the particle to particle bond contains iron combined with alloy metals and interfacial modifier metals. Such bonds contain Fe, and one or more metal selected from Cr, Mn, Mo, Co, Zr, Ti, etc. With interfacial modifiers, the topography of particle surfaces, surface morphology, such as for example, roughness, irregular shape etc., is modified to reduce these inter-particle surface effects. The particulate distribution with individual particles having an interfacially modified surface, although perhaps comprising different particle sizes, has a more homogeneous surface in comparison to non-interfacially modified particulate. The interfacial modifier reduces, such as for example, surface energies on the particle surface permitting a denser packing of particle distributions. In one embodiment the reduction of particle surface energy due to interfacial modification of particle surfaces provides self-ordering of different particle sizes to proceed and results in high volume particle packing. In contrast, particles with no interfacial modification will resist self-ordering.

High volume packing, greater than 60%, 65%, 70%, 75%, 80%, 82%, 85%, or 90 vol. %, can be realized with the claimed compositions. With said high volume fractions, the mechanical properties of the sintered object are improved, such as greater impact resistance, increased densification, resistance to oxidation, minimal shrinkage and improved sintering characteristics for processes in comparison to materials that contain particulate this is not coated with an interfacial modifier. Before sintering, the excluded volume can be less than 40%, 35%, 30%, 25%, 20%, 18%, 15%, or 10 vol. %.

In a product embodiment, a selected particulate having specified particle metallurgy can be combined with a specific amount of an interfacial modifier to form a coating of the modifier on a particle. When sintered, the resulting final shaped article has minimal shrinkage, and enhanced physical/mechanical properties. After sintering, the object or shape can be worked, heated, polished, painted or otherwise finished into new shapes or structures.

Metal particulates can be formed into specific structural parts using conventional technology. Typical useful materials include iron, iron alloys, steel, steel alloys, brass, bronze, nickel and nickel-based alloys, copper, aluminum, aluminum alloys, titanium, titanium alloys, etc. The metallic particulate can be used to make porous materials such as high temperature filters, metering devices or orifices, manifolds, reservoirs, brake parts, iron powder cores, refractory materials, metal matrix composites, and others.

### Sintering Useful Parameters

| Parameter | |
|---|---|
| Volume Rate | 1 to 50 cm³-hr⁻¹ |
| Effective Speed of laser | 1000 to 5000 mm-sec⁻¹ |
| Layer thickness | 10 to 500 microns |
| Power | 100 to 2000 watts |
| Process gas | Inert - non oxidizing or |
| | reducing (AR or N₂) |
| Laser | CO₂ or YAG or similar in |
| | power |

### DETAILED DESCRIPTION OF THE FIGURES

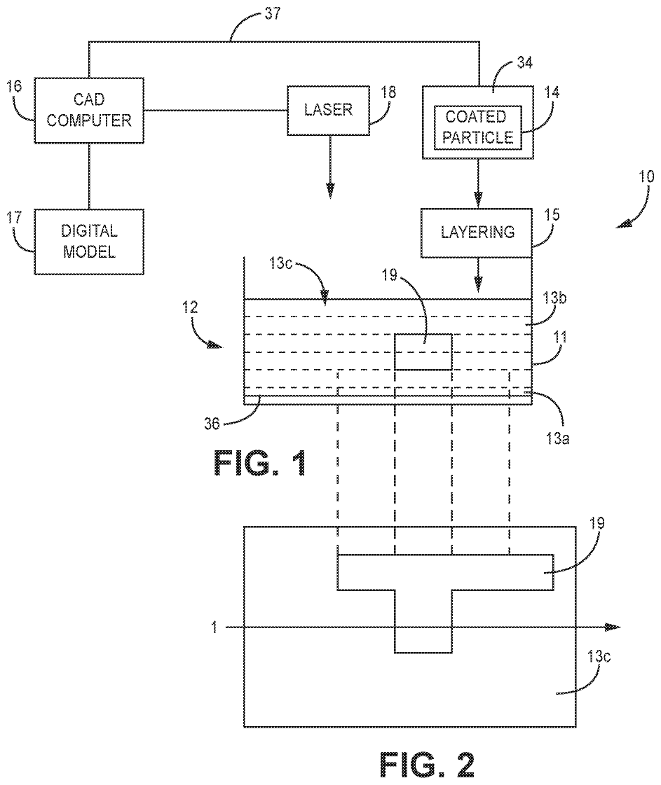

FIG. 1 is a chart of the components of an apparatus flow chart 10 that can achieve object manufacture using directed energy to sinter IM coated particulate. The laser sintering process flow chart 10 is used to form metal objects using laser sintering of IM coated metal particulates. The process involves the use of a CAD computer 16 that can be used to control laser 18 and a layering apparatus 15. The CAD computer 16 uses digital models 17 in the form of computerized routines under digital control 37 to first layer of the coated particulate 13a on stage 36 in container 11 of apparatus 12. The CAD computer 16 then controls the laser 18 to selectively sinter portions of layer 13a to form the portion of the object 19 appropriate for that layer. In the next step, coated particulate 14 from container 34 is layered using layering apparatus 15 to form a second layer of coated particulate on top of the first layer 13a on stage 36. The laser 18 is then used to expose that second layer to laser energy then forming the portion of the object 19 that is appropriate for that layer. As shown in FIG. 1, the container 11 of apparatus 12 is filled with serially formed layers of coated particulates 13a, 13b and 13c and the appropriate portions of each layer is then exposed to laser energy forming the appropriate part of the object 19 that is appropriate for that object. Overall the process as described in FIG. 1 uses a CAD computer to form serially, layers of coated particulate that are serially then exposed to laser energy to form an object 19 using the overall process diagram in FIG. 1.

FIG. 2 shows a top view of the apparatus/flow chart 10 and container 11 and the top layer 13c of the coated particulate. The cross section showing a portion of object 19 of FIG. 1 is illustrated in FIG. 2.

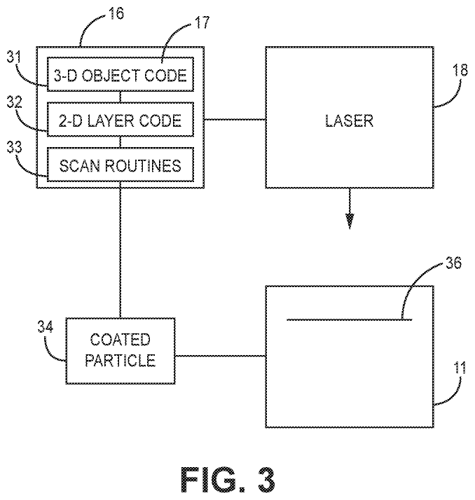

FIG. 3 is a flow chart 30 of the CAD computer control of the sintering processes. The chart 30 shows laser 18 directed to container 11 having stage 36 upon which the layers of coated particulate can be formed 13a. The laser 18 is controlled by CAD computer 16 which is operated using 3D object codes 31, 2D layer codes 32 and scan routines 33 in the computer memory 17. The CAD computer 16 controls both the laser 18 and the coated particulate apparatus that forms the individual layers such as 13a (not shown) onstage 36 of container 11. The 3D object code 31 contains a full image of the object itself and its individual layers which together form the object when each of the serial laser sintering steps are finished. The 2D layer code 32 has computer information that relates to each of the individual layers that once taken together forms the overall 3D object code 31 in the computer memory 17 of CAD computer 16. Stage 36 is placed upon an apparatus within container 11 that can position stage 36 at an appropriate height for the ability of the laser to focus the laser energy exactly on the thin layers of particulate formed on stage 36 in the sequential operation resulting in the formation of the object 19 that is the purpose of the overall process diagram.

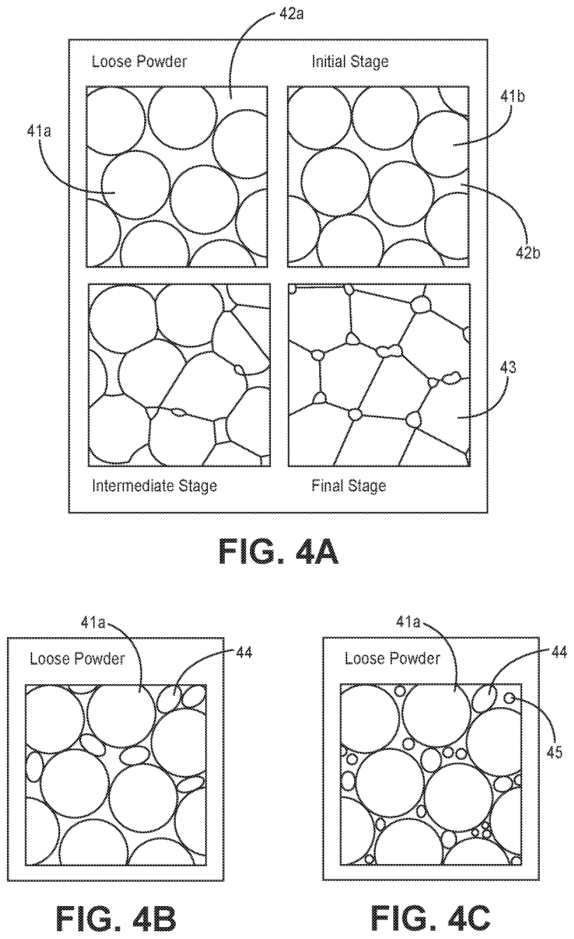

FIG. 4A-4C is an artist's representation of the capacity of the technology to obtain high packing fractions and high density first in the object prior to sintering and in the fused object post sintering. In FIG. 4A is shown a mono disperse particulate collection, 41a, with the excluded volume 42b. Once the initial pre-sintered, “green” piece, workpiece is formed, it is made from a loose powder, but at its initial stage the IM coated particulate becomes self-ordered and increases the bulk density or packing fraction of the particulate. Once sintering begins, the particulate passes through an intermediate stage wherein particles are heat fused at the particle surface to adjacent particles. As the sintering becomes more complete, the final stage results in a highly dense metal object with minimal spaces 44 within the fused object.

FIG. 4B shows the similar assembly of a loose powder, except that this loose powder is a bi-modal distribution of particulate, wherein large particle 41a and smaller particle 44 are combined as a result of the reduced excluded volume results in a better initial packing density or packing volume. Sintering such a structure can obtain a final object having greater density than that from a mono disperse loose powder.

FIG. 4C shows a loose powder having three different particle sizes in the loose powder. In 4C, the larger particle, 41A, is combined a second particle, 44, of a smaller diameter, which is in turn combined with a still smaller particle, 45. Similarly to FIG. 4B, sintering this loose powder having a mixture of three particles of different sizes still further increases final product density.

TABLE 1
Figure Numbering

| FIG. 1 | | |
|---|---|---|
| 10 | Directed beam sintering | |
| | apparatus | |
| 11 | Container for stage and | |
| | particulate | |
| 12 | Sintering assembly | Container, stage, |
| | | layers of particles |
| | | and formed object |
| | | or portions thereof. |
| 13a 13b 13 c | Sequentially formed layers | Thin particulate |
| | of coated particulate | players for serial |
| | | sintering |
| 14 | Coated particulate | IM coated metal |
| | | (particulate?) |
| 15 | Layering control | Forms thin layers |
| 16 | Computer Aided/Controlled | Digital process |
| | Design | control |
| 17 | Digital files of models of | Stored files with |
| | object and particulate layers | models of layers |
| | | structure and layer |
| | | forms of the object |
| 18 | Energy source - Laser | |
| 19 | Object | Formed by |
| | | controlled serial |
| | | sintering of |
| | | particulate layers |
| 34 | Coated particulate | |
| | dispenser/container/source | |
| 36 | Stage | Support for |
| | | particulate layer(s) |
| 37 | Digital control | Particle metering |
| FIG. 2 | | |
| 19 | Object | Formed by |
| | | controlled serial |
| | | sintering of |
| | | particulate layers |
| 13c | Uppermost Layer IM | |
| | coated particulate | |
| FIG. 3 | | |
| 16 | CAD Computer | |
| 17 | Digital code files | Layer and object |
| | | forms |
| 18 | Energy source | Laser or E-Beam |
| 30 | Flow chart | Computer system |
| 31 | Three-dimensional object | Digital code of 3D |
| | form | object |
| 32 | Two-dimensional form for | Digital code of 2D |
| | each layer of finished | Layers |
| | object | |
| 33 | Digital control of energy | Digital routines |
| | beam and particle | |
| | application | |
| 34 | Dispenser/Container/Source | IM coated |
| | of coated articulate | particulate |
| 11 | Container | Maintain |
| | | particulate layers |
| | | and sintered object |
| 36 | Stage | Support for |
| | | particulate layer |
| FIG. 4 | | |
| 41a | Larger particle | |
| 41b | Initial packed larger | |
| | particle | |
| 42a | Excluded or void space | |
| 42b | Excluded or void space | |
| 43 | Sintered particles in | |
| | increased density (from | |
| | packing) | |
| 44 | Smaller particles | |
| 45 | Smallest particles. | |

### Example 1

### Stainless Steel

About 500 g of a 318 stainless steel particulate having a D₉₀ diameter of 70 microns is coated with about 0.1 wt. % of a titanium organo-metallic interfacial modifier. A 50 micron layer having dimensions of 10 cm by 10 cm is formed and using a test annular ring (5 cm in diameter with a wall thickness and width of 5 mm) is formed in the layer using a CO₂ laser at 100 watts using the system with its digital control of the laser to form an annulus having an outside diameter of 5 cm and a thickness of 0.5 cm.

### Example 2

### Carbon Steel

About 500 g of a carbon steel particulate having a D₉₀ diameter of 70 microns is coated with about 0.1 wt. % of a titanium organo-metallic interfacial modifier. A 40 micron thick layer having dimensions of 10 cm by 10 cm is formed and using a test annular ring (5 cm in diameter with a wall thickness and width of 5 mm) is formed in the layer using a CO₂ laser at 100 watts using the system with its digital control of the laser to form an annulus having an outside diameter of 5 cm and a thickness of 0.5 cm.

### Example 3

### Aluminum

About 500 g of an aluminum particulate having a D₉₀ diameter of 70 microns is coated with about 0.1 wt. % of a silicon organo-metallic interfacial modifier. A 30 micron thick layer having dimensions of 10 cm by 10 cm is formed and using a test annular ring (5 cm in diameter with a wall thickness and width of 5 mm) is formed in the layer using a CO₂ laser at 100 watts using the system with its digital control of the laser to form an annulus having an outside diameter of 5 cm and a thickness of 0.5 cm.

### Example 4

### Aluminum

About 500 g of an aluminum particulate having a D₉₀ diameter of 70 microns is coated with about 0.1 wt. % of an aluminum organo-metallic interfacial modifier. A 20 micron thick layer having dimensions of 10 cm by 10 cm is formed and using a test annular ring (5 cm in diameter with a wall thickness and width of 5 mm) is formed in the layer using a CO₂ laser at 100 watts using the system with its digital control of the laser to form an annulus having an outside diameter of 5 cm and a thickness of 0.5 cm.

In summary, as dictated by the specific claims contained herein, represents a breadth of raw material combinations including; metals, inorganic particles, ceramic particles, glass bubble particles, interfacial modifiers, other additives, all with varying particle sizes, weight fractions, and volume fractions. The present embodiment also includes a breadth of processing methods, such as sintering and densification, resulting physical and chemical properties, and end-use applications.

The complete disclosure of all patents, patent applications, and publications cited herein are incorporated by reference. If any inconsistency exists between the disclosure of the present application and the disclosure(s) of any document incorporated herein by reference, the disclosure of the present application shall govern. The foregoing detailed description and examples have been given for clarity of understanding only. No unnecessary limitations are to be understood therefrom. The disclosure is not to be limited to the exact details shown and described, for variations obvious to one skilled in the art will be included within the disclosure defined by the claims.

All scientific and technical terms used herein have meanings commonly used in the art unless otherwise specified. The definitions provided herein are to facilitate understanding of certain terms used frequently herein and are not meant to limit the scope of the present disclosure.

Unless otherwise indicated, all numbers expressing quantities of components, molecular weights, and so forth used in the specification and claims are to be understood as being modified in all instances by the term “about.” Accordingly, unless otherwise indicated to the contrary, the numerical parameters set forth in the specification and claims are approximations that may vary depending upon the desired properties sought to be obtained by the present disclosure. At the very least, and not as an attempt to limit the doctrine of equivalents to the scope of the claims, each numerical parameter should at least be construed considering the number of reported significant digits and by applying ordinary rounding techniques.

Notwithstanding that the numerical ranges and parameters setting forth the broad scope of the disclosure are approximations, the numerical values set forth in the specific examples are reported as precisely as possible. All numerical values, however, inherently contain a range necessarily resulting from the standard deviation found in their respective testing measurements.

All headings are for the convenience of the reader and should not be used to limit the meaning of the text that follows the heading, unless so specified.

While the above specification shows an enabling disclosure of the sintering technology of the disclosure, other embodiments may be made without departing from the spirit and scope of the claimed technology. Accordingly, the disclosed technology is embodied in the claims hereinafter appended. While the above specification shows an enabling disclosure, other embodiments of the system components may be made without departing from the spirit and scope of the claimed subject matter.

We claim:

1. A method for an energy beam selective method of particle sintering, the method comprising:
(i) coating a metal particulate with 0.1 to 2 wt. % of an organometallic interfacial modifier to form a substantially complete coating on the particle, forming a coated particle
(ii) forming a layer of coated particles, the layer having x-y dimensions greater than the dimensions of a desired product the layer having a thickness of about 10 to 100 microns,
(iii) selectively directing a digitally controlled energy beam onto the layer with energy and duration to sinter a portion of the layer into a shape corresponding to the desired product; and
(iv) forming a second layer and repeating step (ii-iii) until the desired product is completed; wherein the digital controlled energy is directed by a computerized image of both the constituent layers and an image of the desired product.

2. The method of claim 1 wherein the energy is a laser energy and the sintering laser beam has a diameter of about 10 to 100 micron.

3. The method of claim 2 wherein the laser energy wavelength is about 100-1000 nanometers at about 500-2000 watts and with a beam a diameter of less than about 50 microns.

4. The method of claim 1 wherein the interfacial modifier is a titanium or zirconium organometallic.

5. The method of claim 1 wherein the thickness of the layer is about 10 to 100 microns.

6. The method of claim 1 wherein the metal particulate comprises stainless steel.

7. The method of claim 1 wherein the metal particulate comprises aluminum.

8. The method of claim 1 wherein the particle has a particle size of D₅₀ of from about 2 to about 200 microns.

9. The method of claim 1 wherein the wherein the metal particulate is a blend of two or more particles that differ either in particle size or in composition.

10. The method of claim 1 wherein the object has a packing density of greater than about 74 percent.
